(19) United States
(12) Patent Application Publication
(10) Pub. No.: US 2012/0288237 A1
(43) Pub. Date: Nov. 15, 2012

(54) OPTICAL FIBER MODULE

(75) Inventors: SZU-MING CHEN, TAIPEI (TW); CHIN-TSUNG WU, TAIPEI (TW)

(73) Assignee: EZCONN CORPORATION, TAIPEI (TW)

(21) Appl. No.: 13/295,327

(22) Filed: Nov. 14, 2011

Related U.S. Application Data
(63) Continuation-in-part of application No. 13/106,063, filed on May 12, 2011.

(51) Int. Cl. G02B 6/36

(52) U.S. Cl. 385/78

(57) ABSTRACT

An optical fiber module includes: an optical transmission line having an optical fiber, a coating enclosing the optical fiber and a buffer layer enclosing the coating, apart of the optical fiber being exposed to outer side of a free end of the optical transmission line; and a fiber stub structure including a sleeve and a retainer section integrally forward extending from the sleeve as an integrated structure. The sleeve has a central hole for accommodating the optical transmission line. The retainer section has an inclined hole for accommodating a part of the optical fiber to make the direction of emergence of the light coaxial with the direction of incidence of the light of the light-emitting element. The fiber stub structure is an integrated structure, whereby the signal loss of incident light is reduced and the manufacturing cost is greatly lowered.

### CROSS-REFERENCE TO RELATED APPLICATION

This is a continuation-in-part of application Ser. No. 13/106,063, filed 12 May 2011, which is now pending.

### BACKGROUND OF THE INVENTION

1. Field of the Invention

The present invention relates to an optical fiber module for optical sub-assembly for transceivers.

2. Description of the Related Art

In an optical fiber communication system, optical sub-assembly for transceivers is an important medium for conversion between optical signals and electrical signals. The optical sub-assembly for transceivers can be classified into transmitting optical sub-assembly (TOSA) for transmitting optical signals, bi-direction optical sub-assembly (BOSA) capable of receiving bi-direction signals in the same optical fiber and tri-direction optical sub-assembly (TRI-DI OSA) capable of receiving both digital signals and analog signals and transmitting digital signals. Either of the TOSA, BOSA and TRI-DI OSA is connected with an optical fiber module 10. Referring to FIG. 1A, the optical fiber module 10 includes a fiber stub structure 11 and an optical transmission line 12 coaxially disposed in the fiber stub structure 11. In general, the optical alignment between the TOSA, BOSA or TRI-DI OSA and the optical fiber module 10 necessitates an X-Y-Z precision positioning stage for performing optical coupling alignment between the optical fiber 13 of the optical transmission line 12 and the light-emitting element of the TOSA, BOSA or TRI-DI OSA so as to transmit optical signals.

The fiber stub structure 11 includes a sleeve 14 and a ferrule 15 coaxially disposed in the sleeve 14 and positioned at a bottom end thereof. The optical fiber 13 partially lengthwise extends into the ferrule 15. The bottom face of the ferrule 15 is an inclined face 16 for preventing reflection light from being incident on the light-emitting element so as to avoid interference of noises with the light-emitting element 17.

Referring to FIG. 1B, as to geometrical optics, the calculation formula of angle of emergence of light beam is as follows:

n SIN(θ1)=SIN(θ1+θ2),

wherein:
n: refractive index of optical fiber;
θ1: grinding angle of optical fiber on the end face of the fiber stub; and
θ2: angle contained between the axis of optical fiber and the direction of emergence of the light.

In the above arrangement, the ferrule 15 is disposed in the sleeve 14 in an upright state. In this case, according to the above formula, the direction of incidence of optical signal of the light-emitting element 17 is collinear with the optical fiber 13 rather than coaxial with the direction of emergence of the light of the optical fiber 13. Therefore, according to the theory that an optimal path is achieved when the direction of incidence of light and the direction of emergence of light, (that is, angle of incidence of light and angle of emergence of light), are coaxial with each other, this will cause loss to incident optical signal and needs to be overcome.

### SUMMARY OF THE INVENTION

A primary object of the present invention is to provide an optical fiber module in which the fiber stub structure is an integrated structure, whereby the signal loss of incident light is reduced and the manufacturing cost is greatly lowered.

To achieve the above and other objects, the optical fiber module of the present invention includes: an optical transmission line having an optical fiber, a coating enclosing the optical fiber and a buffer layer enclosing the coating, apart of the optical fiber being exposed to outer side of a free end of the optical transmission line; and a fiber stub structure including a sleeve and a retainer section integrally forward extending from the sleeve as an integrated structure. The sleeve has a central hole for accommodating the optical transmission line with a part of the optical fiber of the optical transmission line inserted in the inclined hole of the retainer section. The sleeve and the retainer section are integrally connected to form an integrated structure so that the manufacturing cost is greatly lowered. The part of the optical fiber of the optical transmission line is restricted within the inclined hole and disposed in the retainer section in an inclined state to rectify the direction of emergence of the light to be coaxial with the direction of incidence of the light of the light-emitting element. Accordingly, the loss to the incident optical signal is reduced and the optical coupling efficiency is increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a sectional view of a conventional optical fiber module;

FIG. 1B is a sectional view showing that the conventional ferrule is arranged in an upright state, also showing the optical paths of the incident optical signal and the emergent optical signal;

FIG. 2 is a perspective view of the optical fiber module of the present invention;

FIG. 3 is a sectional view of the optical fiber module of the present invention;

FIG. 4 is a sectional exploded view of the optical fiber module of the present invention; and

FIG. 5 is a sectional view showing that the optical transmission line is connected in the fiber stub structure and also showing the optical paths of the incident optical signal and the emergent optical signal.

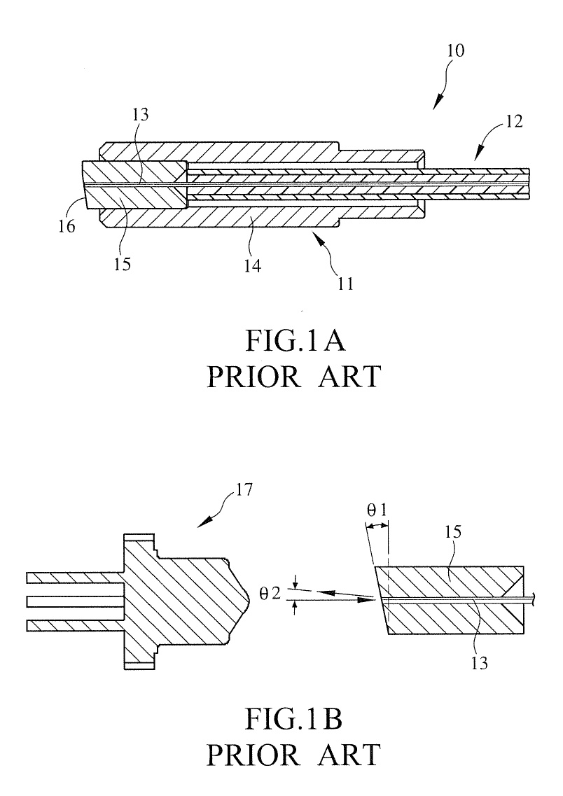

### DETAILED DESCRIPTION OF THE PREFERRED EMBODIMENT

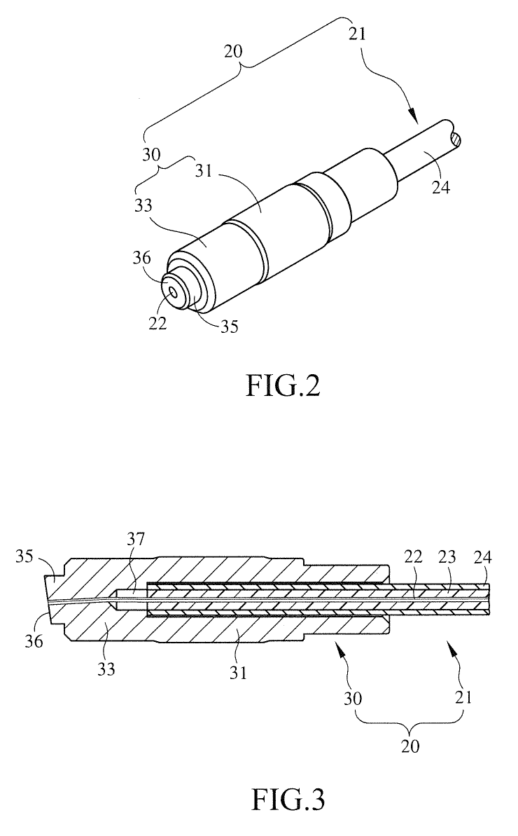

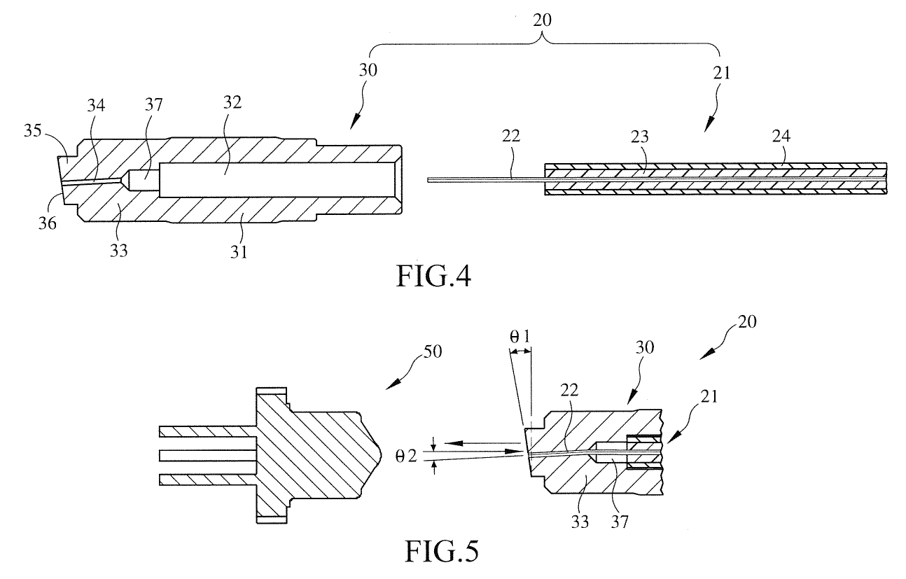

Please refer to FIGS. 2, 3 and 4. The optical fiber module 20 of the present invention includes an optical transmission line 21 and a fiber stub structure 30. The optical transmission line 21 has an optical fiber 22, a coating 23 enclosing the optical fiber 22 and a buffer layer 24 enclosing the coating 23. In practice, prior to installation of the optical transmission line 21 into the fiber stub structure 30, the coating 23 and the buffer layer 24 of a free end of the optical transmission line 21 must be partially removed to expose a part of the optical fiber 22 to outer side of the free end of the optical transmission line 21.

The fiber stub structure 30 includes a sleeve 31 and a retainer section 33 integrally forward extending from the sleeve 31 as an integrated structure. The sleeve 31 has an internal central hole 32. The central hole 32 has such a diameter as to accommodate the optical transmission line 21. The retainer section 33 has an internal inclined hole 34. The inclined hole 34 has such a diameter as to accommodate a part of the optical fiber 22 of the optical transmission line 21. The front end of the retainer section 33 has a hub section 35. The hub section 35 has an inclined front face 36 for preventing reflection light from being directly incident on the light-emitting element so as to avoid interference of noises with the light-emitting element. The fiber stub structure 30 is an integrated structure so that the signal loss of incident light is reduced and the manufacturing cost is greatly lowered.

The retainer section 33 further includes a transition section 37 positioned between the inclined hole 34 and the central hole 32 of the sleeve 31. The transition section 37 has a diameter larger than that of the inclined hole 34, but smaller than that of the central hole 32. Accordingly, the transition section 37 permits the optical fiber 22 to gradually change, whereby the optical fiber 22 can gently turn within the transition section 39. After the turn radius becomes larger, the optical fiber 22 is inserted into the inclined hole 34.

The inclined hole 34 is formed in the retainer section 33 by a predetermined inclination angle, whereby the direction of emergence of the light is coaxial with the direction of incidence of the light to meet the calculation formula of angle of emergence of light beam. Therefore, the optical signals emitted from the light-emitting element 50 can be mass-accumulated and coupled to the optical fiber 22 of the optical transmission line 21 to reduce coupling loss and greatly increase optical coupling efficiency. As shown in FIG. 5, the inclined hole 34 is inclined by an angle θ2 for making the direction of emergence of the light from the retainer section 33 coaxial with the direction of incidence of the optical signals of the light-emitting element 50. In this case, a best optical coupling efficiency can be achieved.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. An optical fiber module for transmitting optical signals, comprising:
an optical transmission line having an optical fiber, a coating enclosing the optical fiber and a buffer layer enclosing the coating, a part of the optical fiber being exposed to outer side of a free end of the optical transmission line; and
a fiber stub structure including a sleeve and a retainer section integrally forward extending from the sleeve as an integrated structure, the sleeve having a central hole for accommodating the optical transmission line, the retainer section having an inclined hole for accommodating a part of the optical fiber.

2. The optical fiber module as claimed in claim 1, wherein the retainer section further includes a transition section positioned between the inclined hole and the central hole of the sleeve, the transition section permitting the optical fiber of the optical transmission line to gently turn within the transition section with the turn radius gradually enlarged.

3. The optical fiber module as claimed in claim 1, wherein the transition section has a diameter larger than that of the inclined hole, but smaller than that of the central hole of the sleeve.

4. The optical fiber module as claimed in claim 1, wherein a front end of the retainer section has a hub section, the hub section having an inclined front face.
